(19) United States
(12) Patent Application Publication
(10) Pub. No.: US 2007/0203777 A1
(43) Pub. Date: Aug. 30, 2007

(54) Method of improving throughput performance of an automotive repair shop

(76) Inventors: James P. Berkey, Monroeville, PA (US); Richard Altieri, Amsterdam, NY (US); TImothy Fitzgerald, Geneva, NY (US)

Correspondence Address: The Webb Law Firm, 700 Koppers Building, 436 Seventh Avenue, Pittsburgh, PA, 15219, US

(21) Appl. No.: 11/655,746

(22) Filed: Jan. 19, 2007

Related U.S. Application Data
(60) Provisional application No. 60/760,467, filed on Jan. 20, 2006.

(51) Int. Cl. G06F 9/46

(52) U.S. Cl. 705/8

(57) ABSTRACT

A method of improving the throughput of an automotive collision repair shop is disclosed comprising the steps of conducting a market analysis of a collision repair shop to determine a potential value of sales by the repair shop; analyzing the relative volume of sales by severity of repair needed for a period of time; analyzing the existing facilities for conducting repairs; and identifying changes in operating procedures and facilities of the repair shop based on the market analysis, relative volume of sales by repair severity and facilities analysis, wherein the identified changes improve the efficiency of the repair shop.

### CROSS REFERENCE TO RELATED APPLICATION

This application claims the benefit of U.S. Provisional Patent Application No. 60/760,467 filed Jan. 20, 2006, which is hereby incorporated by reference in its entirety.

### FIELD OF THE INVENTION

The present invention relates to a method for improving the throughput performance of an automotive repair shop, particularly for increasing the quantity of billable repair hours per day.

### BACKGROUND OF THE INVENTION

Automotive collision repair shops conduct repairs on vehicles that range from simple repairs (requiring a few hours to complete) to complex repairs, which can take over 100 hours to complete. During the repair process, vehicles typically are worked on only 5-20% of the time that they are actually in the repair shop. The remaining time often is spent waiting for the availability of a technician, parts or supplemental parts, a repair bay, specialized equipment or information or the like to continue the repair work. Maintaining consistent and rapid flow of quality repairs through the shop is refered to as the “throughput performance” of the shop. High throughput performance is a significant challenge to repair shop managers, particularly when working in an environment of high variability, including, but not exclusive to, the range in severity from minor repairs to major repairs, incoming volume fluctuations, or consistency in process performance.

Insurance companies generally pay for 90% of all collision repairs conducted in the United States. As such, the top tier insurers control the majority of the available repair opportunities and often use a business model referred to as Direct Repair Program (DRP). A DRP allows insurers to refer repair work to their repair shop of choice and, in some cases, and within federal, state and local guidelines, direct their insurers to their preferred repair shop.

Recently, insurance companies are requiring their DRP repair shops to process insured repairs more quickly to minimize costs and satisfy the vehicle owners, particularly for high performance direct repair programs (DRPs). Repair shops often complete only one to two billable hours of repair work per day on a vehicle. The billable time may or may not correspond directly to the actual time spent working on the vehicle, commonly referred to as the “touch time”.

As such, a need remains for a method of improving the throughput of vehicles through a collision repair shop to maximize the billable hours completed per day for a vehicle.

### SUMMARY OF THE INVENTION

This need is met by the method of the present invention. The method of improving the throughput performance or flow of vehicles through a collision repair shop includes conducting a market analysis of a collision repair shop to determine a potential volume of sales by the repair shop; analyzing the relative volume of sales by severity of repair needed for a period of time; analyzing the existing facilities and any limitations they present to processes used for conducting repairs; and identifying required changes in processes, operating procedures and/or facilities of the repair shop based on the market analysis, flow and/or work-in-process analysis, relative volume of sales by repair severity and facilities analysis, wherein the identified changes improve the throughput of the collision repair shop.

### BRIEF DESCRIPTION OF THE DRAWINGS

FIG. 1 is a work-in-process analysis spreadsheet used in the present invention;

FIG. 2 is an example of a spreadsheet stratifying segments of repair orders by severity; and

FIG. 3 is an example comparing a project plan created by the method of the present invention.

### DETAILED DESCRIPTION OF THE INVENTION

The present invention includes a method and system for developing high performing collision repair shop repair processes.

In general, the method uses at least one of the following types of information as input: a market analysis that defines sales opportunity; current and projected collision repair shop performance requirements; current collision repair shop actual performance determined by work flow through the collision repair shop via an analysis of work-in-process (referred to as WIP); current limitations associated with fixed assets, such as existing buildings and equipment; and current and projected product mix that must be processed.

This information is processed via the method to produce a recommended high performing process or set of processes within a collision repair shop as an output. The method of the present invention is suited for adapting a solution around the varying conditions that impact individual collision repair shops and may be used to enhance brown-field (existing) collision repair shops or to develop recommended collision repair shop processes for green-field (new) collision repair shops. These inputs are detailed below.

One input to the method of the present invention is a market analysis identifying the market potential to design the appropriate high performing collision repair process. The market analysis defines realistic opportunity of new business and/or retention of current business based upon projected performance requirements of the new system and current market conditions including existing market share, projected DRP opportunities and geographical and demographic data that define repair potential. A suitable tool utilized for the analysis is a computerized precision marketing tool that generates a map of the region of a particular collision repair shop and clearly depicts the market potential within the appropriate radius of the collision repair shop.

Another input element to the method of the present invention is an analysis of the work flow in the collision repair shop via analysis of work-in-process (WIP) in the shop. A suitable WIP analysis tool facilitates an analysis of WIP within a collision shop and automatically provides a quick and easily interpretable description of the overall lead time performance throughout the facility; a measure of an hours per day used by insurers to gauge lead time performance; and bottlenecks in the existing collision repair process as depicted by high levels of WIP and lead time at any stage of the repair process. These bottlenecks point to sources of process variation or otherwise poor performance that can negatively impact the performance of collision repair shops.

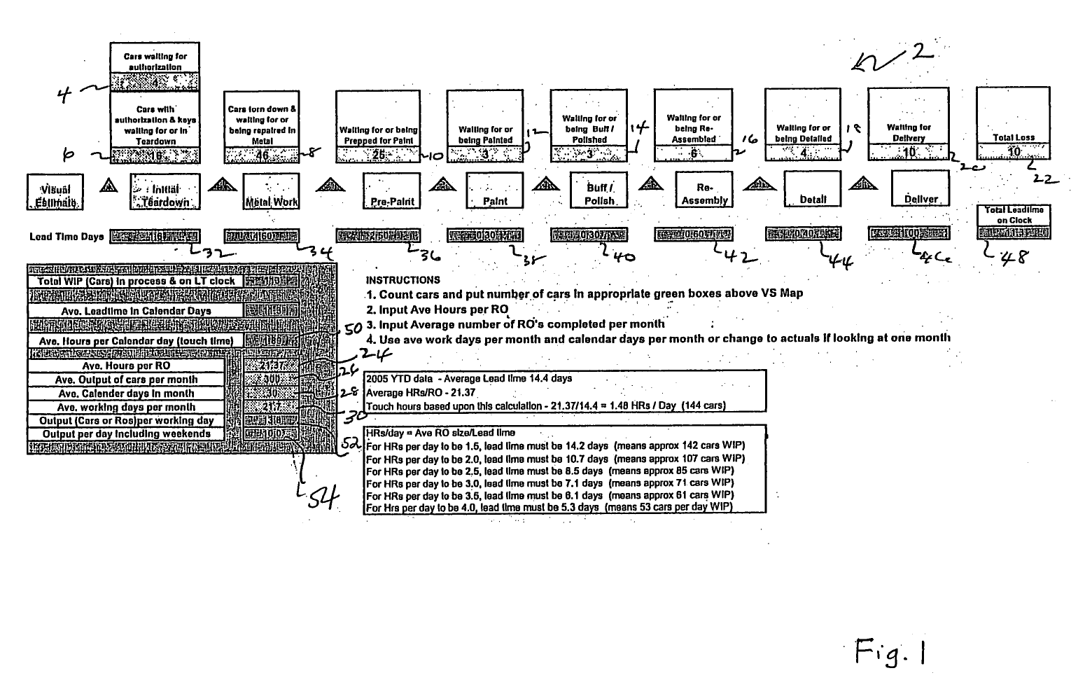

FIG. 1 provides one non-limiting example of a WIP analysis tool and shows a schematic 2 of the value stream of a collision repair shop, indicating lead time (LT) and billable hours per day. In using such a tool, the quantity of vehicles for each stage of the collision process is entered. Ten stages (at 4-22) are shown in FIG. 1 with the quantity of vehicles at each stage indicated as entered by the user. The average number of hours billed per repair order (RO), the average number of repair orders per month, average number of days per month and average number of work days per month are entered by the user at 24-30, respectively. The tool calculates lead time (in days) for each stage and total lead time (at 32-48, respectively), the average touch time (in hours) per day at 50, the number of repair orders completed (“output”) per work week day at 52 and per day (including weekend days) at 54. Such a WIP tool provides an indication of the quantity of vehicles at various stages of the repair process and the length of time that the repair work at each stage requires (lead time). The lead time in a particular stage can be used to identify opportunities for repair work in subsequent stages by calculating the length of time before a vehicle will reach such subsequent stages.

Another input to the method of the present invention is an analysis of existing collision repair shop layout and capital assets. These features may be beneficial to the development of a high-performing collision repair shop process, or they may negatively impact a collision repair shop process. Existing collision repair shops may range in size, with square footage available for production ranging from a very small (3000-5000 sq. ft.) to large centers having 40,000 sq. ft. or more. The capital equipment within the existing collision repair shops can vary and may include but is not limited to features such as the number of refinish paint booths and the number of (or existence of) paint preparation decks used to control the environment during paint priming operations.

Differences in building configuration impact the number of available bays for certain work required in the collision repair process such as estimating, repair planning, metal repair, mechanical repair, frame repair, paint preparation, painting, re-assembly of the vehicle, inspections, detail, delivery to customer, outdoor parking for vehicles in process, and existing layout. In addition, existing building configuration such as multiple buildings, load bearing walls, columns and support structures and the like may limit or restrict processes conducted in a collision repair shop.

Another input to the method of the present invention is an analysis of the existing and anticipated product mix coming to the collision repair shop. By product mix, it is meant the relative volume of sales by severity of repair needed. The product mix is determined using historical data on repairs conducted and the output of the precision marketing tool to determine an expected volume of work. The size and/or severity of repairs varies by collision repair shop. Repair work generally is measured in billable hours, which can vary from less than one billable hour for a very small repair up to in excess of 100 billable hours for repair of a vehicle involved in a heavy collision. The type of repair work also varies in content between operations including but not limited to metal repair, mechanical and frame work, paint preparation and painting, re-assembly, and detail. The specific content of the type of work required and the overall mix of severity of jobs coming into a specific collision repair shop impacts an optimal process.

Likewise, the efficiency of technicians working at a specific collision repair shop impacts shop performance. Technician efficiency is calculated as a ratio of the number of billable hours produced to the actual hours the technician worked. It is not unusual for technician efficiency to vary from 100% to up to 200%. In the present invention, the historical billable hours are factored by the technician efficiency to define the actual required “touch hours” that a technician must actually be working on a car in a given operation. The method of the present invention uses algorithms such as via a spreadsheet tool to input historical billed hours data and translate that data into required resources for specific tasks within the collision repair shop.

The above-described inputs are provided into an iterative process that ultimately defines the product mix, volume of work and the configuration of buildings and equipment, which dictate whether all jobs can be handled in one overall process or whether the work should be split into product families such as a light severity line, a medium severity line, a heavy line or a combination of these options. The process also defines the product mix, volume and configuration of the buildings and equipment, which dictate the degree in which individual processing steps may be broken out into individual processing stations and staffed individually. This iterative process is driven by a mix analysis spreadsheet tool as described below.

A period of historical data (e.g., six months) is collected from a collision repair shop and is stratified into segments of work representing different job categories defined by severity or billable hours within the jobs.

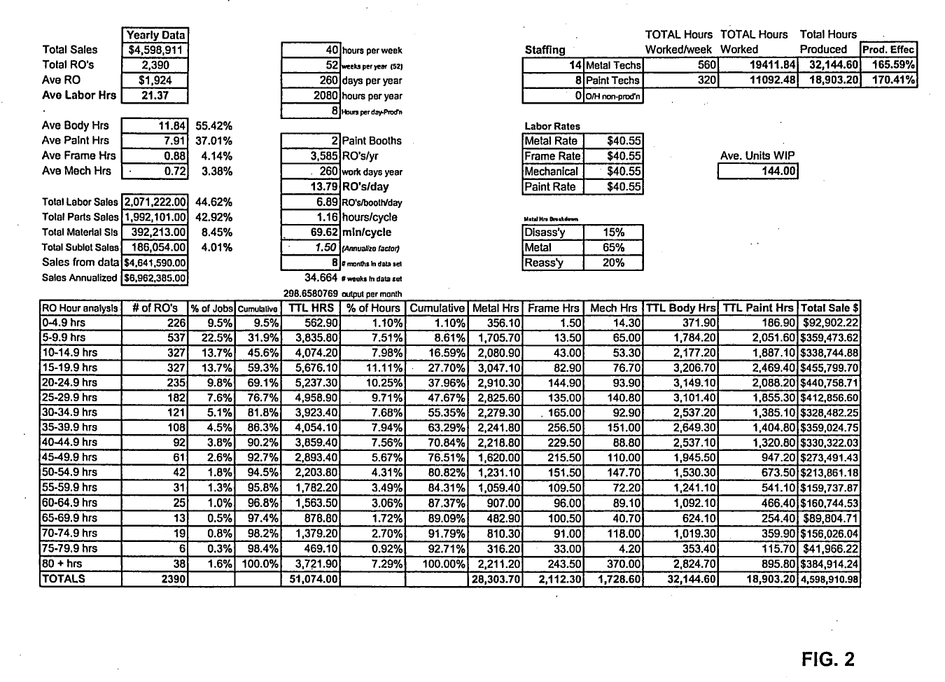

Each segment of work represents the total jobs (or ROs) that fall into a specific job size range or severity range. For example, a first segment of work contains all ROs that fall into a severity range of less than 5 billable hours. The next segment contains all ROs that fall into the severity range from 5 to less than 10 billable hours. The next severity range is from 10 to less than 15 billable hours. This stratification is continued through the entire range of the product mix and typically can include job sizes up to and surpassing 100 billable hours. An example of this stratification is depicted in FIG. 2.

The data set is converted from billable hours to technician “touch hours” or the number of hours required to actually complete the work based on technician efficiency.

Technician efficiencies vary between collision repair shops and therefore this efficiency is factored into a process design. The data table of FIG. 2 is modified by the technician efficiency factor to normalize the data into actual hours required to complete the segments of work stratified by severity as shown in Table 1.

TABLE 1

| | TOTAL | 166% | 166% | 166% | 166% | 166% | 166% | 166% | 170% | |
|---|---|---|---|---|---|---|---|---|---|---|
| Touch | HRS/ | Dsbly/ | Metal/ | Reassy/ | Metal | Frame | Mech | TTL | TTL | Total |
| Hours | RO | RO | RO | RO | Hrs | Hrs | Hrs | Body Hrs | Paint Hrs | Sale $ |
| 0-4.9 hrs | 2.49 | 0.14 | 0.62 | 0.19 | 0.95 | 0.00 | 0.04 | 0.99 | 0.49 | $92,902.22 |
| 5-9.9 hrs | 7.14 | 0.29 | 1.25 | 0.38 | 1.92 | 0.02 | 0.07 | 2.01 | 2.24 | $359,473.62 |
| 10-14.9 hrs | 12.46 | 0.58 | 2.50 | 0.77 | 3.84 | 0.08 | 0.10 | 4.02 | 3.39 | $338,744.88 |
| 15-19.9 hrs | 17.36 | 0.84 | 3.66 | 1.13 | 5.63 | 0.15 | 0.14 | 5.92 | 4.43 | $455,799.70 |
| 20-24.9 hrs | 22.29 | 1.12 | 4.86 | 1.50 | 7.48 | 0.37 | 0.24 | 8.09 | 5.21 | $440,758.71 |
| 25-29.9 hrs | 27.25 | 1.41 | 6.09 | 1.88 | 9.38 | 0.45 | 0.47 | 10.29 | 5.98 | $412,856.60 |
| 30-34.9 hrs | 32.42 | 1.71 | 7.39 | 2.28 | 11.38 | 0.82 | 0.46 | 12.66 | 6.72 | $328,482.25 |
| 35-39.9 hrs | 37.54 | 1.88 | 8.15 | 2.51 | 12.54 | 1.43 | 0.84 | 14.81 | 7.63 | $359,024.75 |
| 40-44.9 hrs | 41.95 | 2.18 | 9.47 | 2.91 | 14.56 | 1.51 | 0.58 | 16.65 | 8.42 | $330,322.03 |
| 45-49.9 hrs | 47.43 | 2.41 | 10.42 | 3.21 | 16.04 | 2.13 | 1.09 | 19.26 | 9.11 | $273,491.43 |
| 50-54.9 hrs | 52.47 | 2.66 | 11.51 | 3.54 | 17.70 | 2.18 | 2.12 | 22.00 | 9.41 | $213,861.18 |
| 55-59.9 hrs | 57.49 | 3.10 | 13.41 | 4.13 | 20.64 | 2.13 | 1.41 | 24.18 | 10.24 | $159,737.87 |
| 60-64.9 hrs | 62.54 | 3.29 | 14.24 | 4.38 | 21.91 | 2.32 | 2.15 | 26.38 | 10.95 | $160,744.53 |
| 65-69.9 hrs | 67.60 | 3.36 | 14.58 | 4.49 | 22.43 | 4.67 | 1.89 | 28.99 | 11.48 | $89,804.71 |
| 70-74.9 hrs | 72.59 | 3.86 | 16.74 | 5.15 | 25.75 | 2.89 | 3.75 | 32.40 | 11.12 | $156,026.04 |
| 75-79.9 hrs | 78.18 | 4.77 | 20.69 | 6.37 | 31.83 | 3.32 | 0.42 | 35.57 | 11.32 | $41,966.22 |
| 80+ hrs | 97.94 | 5.27 | 22.84 | 7.03 | 35.14 | 3.87 | 5.88 | 44.89 | 13.83 | $384,914.24 |
| TOTALS | 12.76 | 1.07 | 4.65 | 1.43 | 7.15 | 0.53 | 0.44 | 8.12 | 4.64 | $4,598,910.98 |
| Equivilent | 22.00 | 1.85 | 8.01 | 2.47 | 12.33 | 0.92 | 0.75 | 14.00 | 8.00 | |
| People | | | | | | | | | | |
| ROs/Day | 13.8 | | | | | | | | | |

With the data in the format of Table 1, the analysis continues with an iterative process of selecting product families based upon severity. It may be advantageous for a collision repair shop to process ROs in the severity range of 0-25 billable hours in a separate “light severity” process designed and dedicated to that product family.

By selecting all segments of work up to and including 25 billable hours, the outcome is a subset of the original product mix. The spreadsheet tool provides the ability to analyze the equivalent manpower needed to process this subset of work based upon the volume of ROs and the mix of work within those ROs. The spreadsheet tool indicates the equivalent manpower required for each major element of the repair process, including teardown or dismantling the car, metal repair, mechanical repair, frame work, paint preparation and paint and re-assembly. Volume and mix impact the degree in which subsets of the entire product range may be produced separately and still result in reasonable manpower requirements in each major step of the repair process. As an example, if a low volume collision repair shop stratifies its work into several individual product families, the resulting manpower requirements would be expressed in terms of small fractions of equivalent employees. This solution would be impractical and cost prohibitive, forcing the shop to run more of the product mix or all of the product mix in one holistic process. Instead, a low volume collision repair shop may be better suited to stratify its work into only a few product families or use no stratification at all. By contrast, a higher volume collision repair shop may find it helpful to stratify its work into many product families to better manage its product mix.

The iterative nature of this analysis lies in evaluation of various possible alternative means of stratifying the mix. Another possible factor in stratifying the mix would be to develop a unique process for a certain segment of work done for a specific insurer DRP program. In any case, the analysis is conducted for each subset of the mix that will be processed individually or, in the case of small shops, the entire mix as a whole.

The output of the above-described analysis is a recommended process configuration or set of processes that are appropriate for the specific collision repair shop. Output data from the analysis defines the required number of technicians in each major area of the process including teardown/disassembly, metal repair, mechanical repair, frame repair, paint preparation and painting and re-assembly.

In this manner, the method determines whether or not to use a single process to handle the entire product mix or, alternatively, a set of processes targeted at specific subsets of the mix. The method also recommends the manpower requirements for the processes.

Finally, the method translates the technician requirements for each process into a physical process layout that provides adequate stalls for technicians to complete their work. The number of stalls required for each technician can vary from several to less than one. The objective is to minimize the number of work stalls per technician. The output of the WIP and HRs per day analysis is used to understand current bottlenecks in the existing processes. The degree in which the root causes of these bottlenecks can be eliminated in the new process design is a factor in determining how many work stalls to allot each technician. Another factor in allotting work stalls to a technician is the amount of variation in severity of work that exists in the proposed new process. The more stratification that is possible (creating individual processes for separate product families around severity), the less variation will exist in each proposed process. These two factors and the current building and equipment constraints are utilized to develop a proposed shop layout around the newly proposed processes.

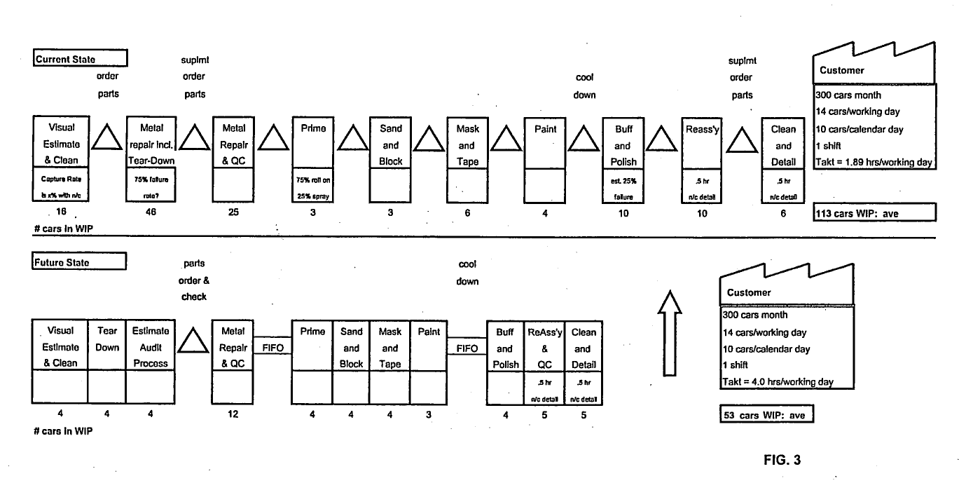

FIG. 3 depicts an example of a project plan for a collision shop prior to use of the present invention (“current state”) and afterwards (“future state”). The quantity of billable hours more than doubled from 1.89 hours/day to 4 hours/day with a reduction in the quantity of vehicles in the shop at a time from 113 to 53.

While the preferred embodiments of the present invention are described above, obvious modifications and alterations of the present invention may be made without departing from the spirit and scope of the present invention. The scope of the present invention is defined in the appended claims and equivalents thereto.

What is claimed is:

1. A method of improving the throughput of an automotive collision repair shop comprising:
conducting a market analysis of a collision repair shop to determine a potential value of sales by the repair shop;
analyzing the relative volume of sales by severity of repair needed for a period of time;
analyzing the existing facilities for conducting repairs; and
identifying changes in operating procedures and facilities of the repair shop based on the market analysis, relative volume of sales by repair severity and facilities analysis, wherein the identified changes improve the efficiency of the repair shop.

2. The method of claim 1, wherein the market analysis includes a map of a geographic region of the collision repair shop depicting market potential in the geographic region.

3. The method of claim 1, wherein the relative volume of sales by severity of repair is determined from historical data on repairs conducted by the repair shop.

4. The method of claim 3, wherein the relative volume of sales by severity of repair is categorized into segments by quantity of billable hours for repair.

5. The method of claim 4, wherein the quantity of billable hours for each segment ranges by 5 hours.

6. The method of claim 4, wherein the billable hours is converted to touch hours to determine the number of hours required to complete the repair work.

7. The method of claim 4, wherein the number of hours for each of metal repair, frame repair, mechanical repair and painting is determined for each segment.
